(19) United States
(12) Patent Application Publication
(10) Pub. No.: US 2026/0178467 A1
(43) Pub. Date: Jun. 25, 2026

(54) METHOD, APPARATUS AND SYSTEM FOR DEBUGGING ELECTRONIC DEVICES

(71) Applicant: Trident IoT, LLC, Carlsbad, CA (US)

(72) Inventors: Brandon Gruber, San Marcos, CA (US); Lucca Fabani, Encinitas, CA (US)

(21) Appl. No.: 18/987,933

(22) Filed: Dec. 19, 2024

(51) Int. Cl. G06F 11/362; H04W 24/08

(52) U.S. Cl. CPC G06F 11/362; H04W 24/08

(57) ABSTRACT

A system, method and apparatus is described for debugging electronic devices. An RF packet capture device and related software produces packet capture files, which are automatically analyzed to detect suspect data records indicative of an anomaly. A packet analysis file may be produced where the suspect data records are emphasized to make identification of such suspect data records easier to find by a development engineer. The packet analysis file may further be analyzed to determine a cause of an anomaly and a solution to the anomaly.

### BACKGROUND

### I. Field of Use

The present application relates generally to the design and development of Internet-of-Things (IOT) devices, and more specifically to various embodiments of a system, apparatus and method for debugging such devices during development.

### II. Description of the Related Art

The Internet-of-Things (“IoT”) is a term of art that describes the recent proliferation of small, battery-powered electronic devices, such as smart vacuum cleaners, smart toothbrushes, security sensors, environmental sensors, HVAC sensors, power sensors, water sensors, temperature sensors, etc. Such IOT sensors typically utilize wireless, low-power communication technology and protocols, such as Z-Wave, Zigbee, Thread, Matter, Bluetooth, etc.

One of the challenges of developing such IoT devices is debugging them during development. Oftentimes, a wireless “sniffer” is used to capture RF “traffic” between devices over time, demodulate the RF transmissions into data packets, analyze the packets and present various information pertaining to each packet in the form of a “sniffer trace”. Each packet captured by a wireless sniffer may contain information such as a source and/or destination IP or MAC address, an RSSI value, a date and time of transmission, a data rate, a channel number, a home ID, a node ID, a packet type (i.e., data packet, ACK, singlecast, multicast, etc.), and a representation of the packet itself, such as in the form of a hexadecimal string.

When debugging an IOT device, an engineer may review a sniffer trace to help debug the device. This may include manual review of each line of a sniffer trace in order to determine if there are any packets that provide a clue as to the nature of an error. However, a sniffer trace may contain many hundreds or even thousands of entries, each entry representing a particular packet, each packet containing the information described above. Thus, it may be at least time-consuming, if not impossible, for even an experienced engineer to understand why a particular problem is occurring based on a sniffer trace.

### SUMMARY

Embodiments of the present invention are directed towards systems, methods and apparatus for debugging electronic devices, particularly during development. In one embodiment, a system is described, comprising an RF packet capture tool for detecting RF data packets transmitted in a wireless network comprising the electronic device and for generating a packet capture file comprising a plurality of data records each associated with one of the RF data packets, respectively, and a computer, comprising a memory for storing computer-executable instructions and a processor for executing the processor-executable instructions that causes the computer to identify data records of the packet capture file that indicate an anomaly associated with the electronic device, generate a packet analysis file from the packet capture file comprising a copy of the data records and visually emphasizing data records in the packet analysis file that have been identified as causing the anomaly for ease of debugging the electronic device and provide the packet analysis file to a display for viewing by a user of the system.

In another embodiment, a method is described for debugging electronic devices, comprising generating a packet capture file from RF data packets received by an RF packet capture tool located in a wireless network, the packet capture file comprising a plurality of data records each associated with one of the RF data packets, respectively, identifying suspect data records that indicate an anomaly associated with the electronic device generating a packet analysis file from the packet capture file, wherein generating the packet capture file comprises copying the data records of the packet capture file into the packet analysis file and visually emphasizing at least the suspect data records for ease of debugging the electronic device, and displaying the packet analysis file to a user.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 is a block diagram of one embodiment of a system for debugging wireless electronic devices;

FIG. 2 is a functional block diagram of one embodiment of a computer as shown in FIG. 1, configured for debugging electronic devices;

FIG. 3 is an illustration of one embodiment of a modified sniffer trace including a first heat map and a second heat map;

FIG. 4A is an illustration of the first heat map as shown in FIG. 3, with data records of the first heat map expanded and spaced apart from each other;

FIG. 4B is an illustration of the second heat map as shown in FIG. 3, with data records of the second heat map compressed and spaced closer together;

FIG. 5 is a functional block diagram of one embodiment of another system for debugging electronic devices;

FIGS. 6A and 6B represent a flow diagram illustrating one embodiment of a method for debugging an electronic device using one or more trained machine learning models; and

FIGS. 7A and 7B represent a flow diagram illustrating another embodiment of a method for debugging an electronic device.

### DETAILED DESCRIPTION

Disclosed are embodiments of a system, method and apparatus for debugging electronic devices. Specifically, packet capture files (i.e., sniffer traces) of an RF packet capture tool (i.e., an RF sniffer) are automatically analyzed to identify data records in the packet capture files that may be associated with anomalies of an electronic device or a local wireless communication network. These embodiments provide significant technical improvements to traditional RF sniffers by automatically identifying suspect records in packet capture files to aid debugging by an engineer.

The disclosed embodiments herein are a departure from the prior art which, heretofore, required highly-skilled engineers to analyze packet capture files in order to understand anomalies in a device under test, such as a device not communicating with other devices, a device that consumes more power than it was designed to consume, dropping data packets, intermittent problems, etc. Analyzing packet capture files is a time-consuming process, as packet capture files can contain thousands of records that need to be manually analyzed by an engineer. Moreover, manual analysis of packet capture files alone may not point an engineer to a solution to an anomaly, requiring further time and expense for an engineer to a generate a solution to an anomaly.

Embodiments of the present invention solve these long-felt needs by automatically analyzing packet capture files with a computer specially configured to identify records that may be associated with an anomaly and further, in some embodiments, additionally provide a cause and a solution to the anomaly.

It should be understood that although the embodiments may utilize standard computer components, such as a processor, memory, user interface, etc., it is important to remember that the specific features, steps and limitations of the described embodiments, both alone and in combination with each other, provide a new and non-obvious, specific technical solution to specific technical problem that is necessarily rooted in computer technology and thus constitutes an inventive concept-something more than an abstract idea merely implemented on a generic computer.

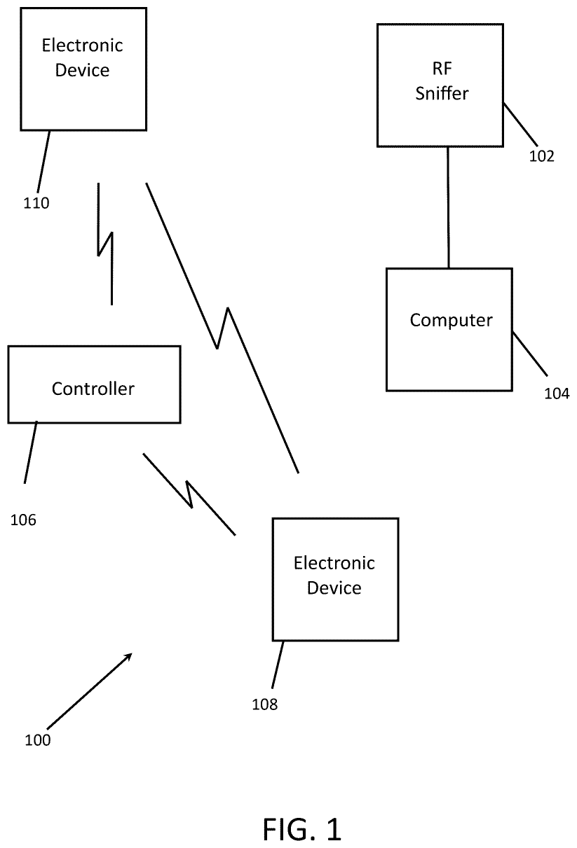

FIG. 1 is a block diagram of one embodiment of a system 100 for debugging wireless electronic devices. Shown is an RF packet capture tool (i.e., an RF sniffer) 102 (herein referred to as an RFPCT), computer 104, local network controller 106, a first electronic device 108 and a second electronic device 110. A local-area network is formed by controller 106 electronic device 108 and ed 110, where controller 106 communicates wirelessly with each of electronic device 108 and 110 via a local-area wireless protocol, such as any variety of 802.11-compatible protocols, Zwave, Zigbee, Matter, Threat, etc. While only two electronic devices are shown in FIG. 1, typically many more electronic devices are used in connection with controller 106 when system 100 is deployed in a residence or business. However, during development of an electronic device, an engineer may test and debug an electronic device using only a minimal setup, such as the one shown in FIG. 1.

In some embodiments, electronic device 108 and electronic device 110 comprise Internet-of-Things (IOT) devices, i.e., typically consumer-grade, battery-powered, wireless electronic devices that are typically connected to the Internet and can communicate with other devices and systems. These wireless electronic devices, also known as “smart devices”, may comprise sensors, firmware, transceivers and other technologies that allow them to collect and exchange data. Examples of IOT devices are wireless security sensors (such as door sensors, window sensors, motion sensors, etc.), thermostats, smart appliances, smart door locks, wireless cameras, etc. Controller 106 may be referred as a wireless “hub”, “smart hub” or gateway, used as a central “brain” of the local network and serves as a gateway to the Internet for any connected electronic devices. Examples of controller 106 comprise a SmartThings® hub, a Ring® security hub, a Vivint® smart hub, etc.

RFPCT 102 is a tool for debugging wireless devices in the local wireless network. These wireless sniffers may operate in a promiscuous mode, capturing all wireless data packets as they are transmitted by devices in the local-area network, sometimes in a particular channel and/or frequency to which the sniffer is tuned. RFPCT 102 typically comprises an RF receiver and a processor for converting received RF data packets into hexadecimal values. These hex values are then typically provided to on-site computer 502 via USB or local wireless network, where they are processed by an RFPCT software that parses the hex values and generates a data record for each data packet that is received in a graphical format and provides the information for presentation to a user, such as an engineer, typically via computer 104. A “packet capture file” comprises a series of data records over time, often numbering in the thousands. A packet capture file refers to a record of network data packets captured by an RFPCT, which allows one to monitor and analyze detailed information of data packets traveling within a wireless network at specific points in time. Each data packet received by an RFPCT is demodulated and a “data record” is produced, comprising one or more of the following: a date and a time that a data packet was received, a data rate of the packet, a channel number over which the packet was transmitted, an identification of a node that transmitted the packet (i.e., a serial number, node ID, MAC address, IP address, etc.), an identification of the intended recipient of the packet (i.e., a serial number, node ID, MAC address, IP address, etc.), an RSSI value, a delta indicating the elapsed time from the last packet received, an identification of the local-area network (i.e., a home ID, PAN, etc.), a type of data packet (i.e., command, response, ACK, a command, singlecast, multicast, broadcast, etc.) and a digital value of the packet (i.e., such as a hexadecimal representation of the packet). The format of a packet capture file may depend on a wireless communication protocol type and/or particular sniffers available in the marketplace.

In accordance with the teachings herein, packet capture files are provided to computer 104, which is configured to automatically analyze the data records in the packet capture file and identify suspect individual data records, groupings of data records and/or or pre-defined patterns of data records, from one or more devices in a network over time, that may be associated with an anomaly of an electronic device (each of the foregoing “suspect” data records). An “anomaly” may be referred to herein broadly as a technical problem with a device, such as an inability to transmit, an inability to receive, dropping unexpectedly off of a local-area network, dropping packets, etc.

Computer 104 may use traditional techniques to identify suspect data records, or it may use a machine learning model specifically trained to detect such anomalies that learns over time how to better detect such suspect data records.

After analyzing a packet capture file, computer 104 may generate a packet analysis file comprising, in one embodiment, a copy of the packet capture file that visually emphasizes data records that have been identified as suspect, for ease of debugging an electronic device. For example, computer 104 may highlight suspect data records in bold, underline, italics and/or colored highlight in the packet analysis file. In other embodiments, a packet analysis file may comprise other formats for identifying suspect data packets, such as a listing of only suspect data records. The packet analysis file may then be presented to an engineer for manual analysis. In one embodiment, the packet analysis file may additionally comprise a “heat map” [0026] that may be displayed along with the packet analysis file to quickly and easily allow a user of computer 104 to identify suspect data records associated with anomalies.

In another embodiment, computer 104 may generate one or more potential causes of an anomaly.

In one embodiment, computer 104 may generate one or more potential solutions to an anomaly, such as a textual message instructing an engineer to perform one or more actions, such as to increase a transmit power of an electronic device under test, to increase a wireless transceiver sensitivity, or a suggestion to modify embedded computer-executable instructions in an electronic device under test. In some embodiments, the suggestion to modify the embedded computer-executable instructions may additionally comprise modified source code associated with the embedded computer-executable instructions in embodiments where computer 104 may have access to source code associated with the embedded computer-executable instructions.

In an embodiment where computer 104 utilizes machine learning, computer 104 may utilize a one or more trained machine learning models to analyze packet capture files, each trained model particular to a particular anomaly. For example, a first trained model may be particularly suited to detect a dropped packets anomaly while a second trained model may be particularly suited to detect power consumption rates in excess of designed power consumption rate. In another embodiment, each trained model may be particularly trained for a particular local wireless network protocol. For example, a first trained model may be capable of analyzing packet capture files produced from receiving Zwave data packets, while a second trained model may be capable of analyzing packet capture files produced from receiving Zigbee data packets. In one embodiment, the processor-executable instructions of computer 104 may comprise an initial trained model and additional trained models may be added later, to address additional anomalies or additional local-area wireless communication protocols.

In one embodiment, computer 104 is configured to receive representative data records or patterns of data records indicative of a particular anomaly (referred to herein as an “anomaly definition”) and add the anomaly definition to other anomaly definitions associated with other types of anomalies previously provided to computer 104. In one embodiment, at least some of the anomaly definitions may be enabled or disabled by an engineer operating computer 104 in order to focus on a particular type of anomaly that may be occurring with an electronic device under test. When an anomaly definition is enabled, computer 104 evaluates a packet capture file in accordance with each anomaly definition that is enabled and ignores anomaly definitions that have not been enabled.

In one embodiment, computer 104 may execute two or more sets of processor-executable instructions, each set defining a different machine learning model. For example, a first set of processor-executable instructions defining a first machine learning model may analyze a packet capture file and provide an identification of one or more anomalies found in the trace and an annotated version of each trace to a user of computer 104. Each annotated packet capture file may then be analyzed by a second set of processor-executable instructions defining a second machine learning model that identifies one or more causes associated with any identified anomalies. The cause(s) of an anomaly may then be provided to the user of computer 104. The cause(s) and the annotated packet capture file may also be analyzed by a third set of processor-executable instructions defining a third machine learning model that receives a listing of the identified anomaly(s) and, in response, may provide one or more solutions to one or more of the identified anomalies. In one embodiment, a solution may comprise a text-based suggestion to modify a hardware or firmware attribute, such as increasing the gain of a front- and amplifier, or to review an identified portion of source code associated with firmware in the electronic device under test. For example, the third machine learning model may suggest the user review a particular library that may be associated with one or more of the identified anomalies.

In another embodiment, the third machine learning model may access source code associated with firmware in an electronic device under test, locate code associated with one or more of the identified anomalies, modify portions of the source code associated with the one or more identified anomalies and present the modified source code to the user. The user may then use the modified source code to create a new executable file, load the new executable file into the device under test, and repeat test conditions in order to confirm if the suggested source code modification alleviates one or more of the detected anomalies.

In one embodiment, computer 104 may be configured to receive an indication from a user of computer 104 of a “user category” of the user, i.e., whether the user is an experienced software developer or other engineer, a customer support person, an installer, etc. In response, computer 104 may tailor its response to the user, such as to only identify/report suspect data records associated with a particular type of anomaly (such as to identify/report only suspect data packets associated with radio communication issues in the field) when the user category is “installer”.

In one embodiment, computer 104 may be configured to receive a query from a user of computer 104 asking computer 104 to identify records in a packet capture file associated with an anomaly associated with one or more electronic devices. For example, a query may comprise a question such as, “what is wrong with sensor 110?”, “find out why sensor 108 is not responding”, “show me data records in the packet capture file+/−20 data records of when sensor 108 went offline”, “show me data records that match this pattern (where the user may provide one or more sample data records to computer 104). In response, computer 104 processes the query and analyses the packet capture file in accordance with the query to identify pertinent data records in association with the query or command.

In one embodiment, computer 104 may be configured to analyze packet capture files in accordance with multiple wireless communication protocols, such as Zwave and Zigbee, for example. In one embodiment, computer 104 may be configured to analyze packet capture files to identify patterns of data records indicative of one or more predetermined anomalies. In one embodiment where computer 104 is configured to analyze packet capture files associated with a first wireless communication protocol, computer 104 may be additionally configured at some later time to add one or more additional capabilities to analyze packet capture files associated with one or more other wireless communication protocols.

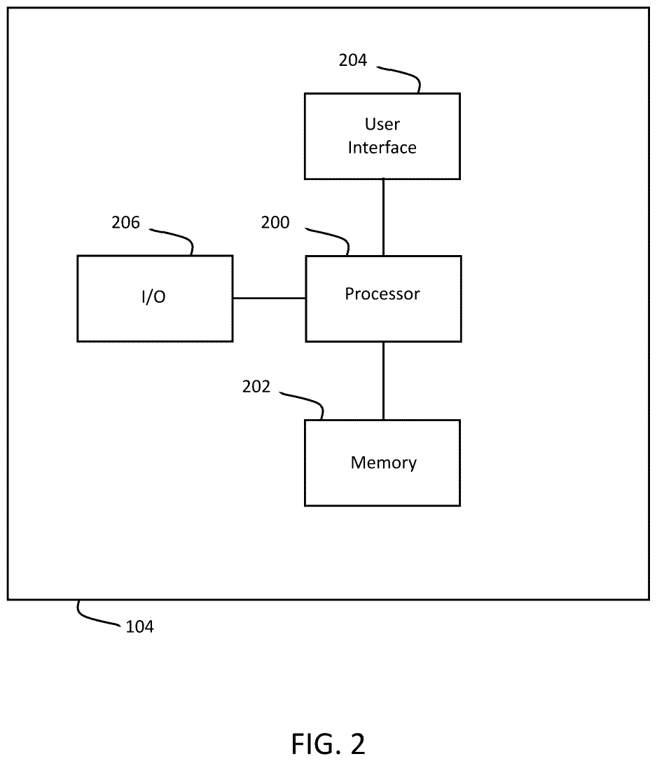

FIG. 2 is a functional block diagram of one embodiment of computer 104, as well as computers 502, 504 and 506, described later herein. FIG. 2 shows processor 200, memory 202, user interface 204 and I/O port 206. It should be understood that, in some embodiments, the functional blocks may be connected to one another in a variety of ways and that not all functional blocks are necessary for operation of computer 104 (such as a power supply), for purposes of clarity.

In some embodiments, any one or more of the aforementioned computers may comprise a machine learning function or other pattern-identifying function to automatically analyze packet capture files from RFPCT 102, identify data records to identify anomalies and, in some embodiments, offer a cause and/or a solution to solve the anomalies. For example, over time, computer 104 may observe that certain trends or patterns in the data records of packet capture files correspond to certain anomalies such that they may be more readily and quickly addressed and solved. In some embodiments, packet capture files may be analyzed based on a particular wireless protocol, such as Zwave, Zigbee, Matter, Thread, etc.

Processor 200 is configured to provide operational functionality of the aforementioned computers as processor 200 executes processor-executable instructions stored in memory 202, for example, executable code. Processor 200 typically comprises one or more programmable microprocessors, microcomputers, microcontrollers, custom ASICs, System-on-Chips (SoCs), System-in-Packaging (SiP), or the like, and where two or more processors are used, each of the processors, either alone or in combination, may execute one or more of the processor-executable instructions that cause the processor to perform various functions. Processor 200 may be selected based on a variety of factors, such as computational power and cost.

Memory 202 is coupled to processor 200, comprising one or more information storage devices, such as RAM, ROM, flash memory, or some other type of electronic, optical, or mechanical memory device(s). Memory 202 is used to store processor-executable instructions for functional operations of the aforementioned computers, as well as any information used by processor 200 during functional operations, such as one or more anomaly definitions, one or more trained machine learning models, data records associated with packet capture files, etc. It should be understood that memory 202 is non-transitory, i.e., it excludes propagating signals, and that memory 202 could be incorporated into processor 200, for example, when processor 200 is, for example, an SoC. It should also be understood that once the processor-executable instructions are loaded into memory 202, processor 200 may be considered to be a specialized processor for performing novel and non-obvious functions, such as an ability to automatically analyze packet capture files, identify suspect data records potentially associated with an anomaly and, in some embodiments, offer a cause and/or a solution to an anomaly.

User interface 204 is coupled to processor 200, used to allow a user of a computer to enter and receive information. User interface 204 comprising means for allowing communications between a user of computer 104 and processor 200, such as a video monitor, mouse, keyboard, touchscreen, stylus, audio speaker, microphone, etc.

In an embodiment where a computer comprises a web-based computer server, a user of a local computer can be used to communicate with the web-based computer server. In this case, user interface 204 may comprise a video monitor, mouse, keyboard, touchscreen, audio speaker, microphone, etc. associated with the on-site computer, and information is conveyed to computer 104 across a wide-area network, such as the Internet, and I/O port 206 of computer 104.

I/O port 206 is coupled to processor 200, comprising well-known hardware, such as an Ethernet port, Wi-Fi transceiver, data buss port, etc, for sending and receiving digital information, typically as data packets in accordance with one of many well-known protocols.

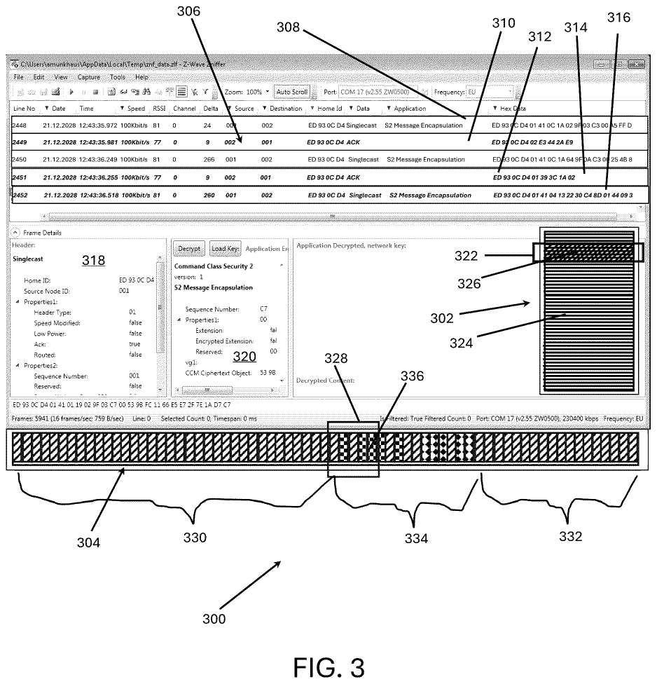

In one embodiment, a packet analysis file may comprise a “heat map” that may be displayed along with the packet analysis file to quickly and easily allow a user of computer 104 to identify suspected data records associated with anomalies. FIG. 3 is an illustration of one embodiment of a packet analysis file 300 including a first heat map 302 and a second heat map 304. One or both heat maps may be generated by RFPCT 102 or in a packet analysis file as provided by computer 104. Also shown is a main packet capture file window 306, listing a number of data records 308-316, frame details window 318, and decrypt/key window 320. It should be understood that the structure of the data records and layout of the various components shown in FIG. 3 are exemplary, and that other data records structures and layout are contemplated.

Heat map 302 comprises a window typically showing a representation of all of the data records of a packet capture file. The representation may comprise a series of lines, geometric shapes, such as a series of rectangles, micro text of some or all of the actual data records of packet analysis file 300, etc. Slider 322 represents a window of time, in this example, representing about 1/10 of the total packet capture file. Slider 322 is movable by a user of computer 104 using a mouse, keyboard or other human interface device, so that as slider 322 moves, the data records in main sniffer window 306 change too, showing the data records that are represented in slider 322.

In this example, heat map 302 shows representations 324 of expected data records for much of the packet capture file, except for the data record representations 326 within slider 322 representing at least some suspect data records that may be associated with an anomaly. The suspect data records are emphasized in main sniffer window 306, in this example, in bold and italics. Thus, emphasizing representations suspect data records in slider 322 may make it easier for a user of computer 104 to quickly identify suspect data records without having to manually pour through an entire packet capture file.

Heat map 304 comprises a window, in this embodiment, rendered horizontally at the bottom of the packet analysis file, showing a representation of all of the data records of the packet capture file. In this example, each data record of a packet capture file is represented in heat map 304 as a “block”, as shown. Slider 328 represents a window of time, again representing about 1/10 of the total packet capture file. Slider 328 is movable by a user of computer 104 using a mouse, keyboard or other human interface device, so that as slider 328 is moved horizontally over heat map 304, the data records in main sniffer window 306 change too, showing data records that are represented within slider 328.

In this example, heat map 304 shows representations of expected data records for much of the packet capture file, in representations 330 and 332, while also showing representations 334, indicating several suspect data packets. Slider 328 contains at least some of these represented suspect data records 336, and the suspect data records themselves are shown in main viewing window 306 and emphasized, again in this example, in bold and italics. Again, representing actual data records in heat map 304 may make it easier for a user of computer 104 to quickly identify suspect data records without having to manually pour through an entire packet capture file.

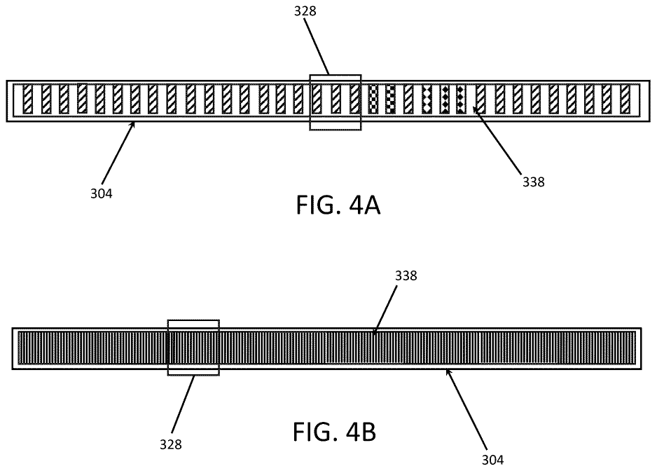

In some embodiments, heat map 304 may be expanded or compressed as shown in FIGS. 4A and 4B. In FIG. 4A, data records 338 of heat map 304 have been expanded and spaced apart from each other such that a small gap in time exists between each data record. Slider 328 may remain the same size as shown in FIG. 3, or it may be dynamically resized in proportion to the compression or expansion of the data records such that the same number of data records is displayed in main viewing window 306 as the data records are compressed or expanded. Expansion or compression of data records 338 may be accomplished by a user of computer 104 using user interface 204, such as by scrolling a wheel of a mouse, left or right clicking on a mouse while moving the mouse, using a combination of keyboard commands, using a stylus, etc.

In FIG. 4B, data records 338 of heat map 304 have been compressed and are represented only by a short vertical line. By compressing the data records to a maximum amount, a representation of an entire packet capture file may be shown all at once, and a user may use slider 328 to quickly move to different portions of the packet capture file. Of course, as slider 328 is moved, data records displayed in main viewing window 306 scroll in accordance with the movement of slider 328.

In one embodiment, the computer-executable instructions may comprise instructions that causes computer 104 to automatically analyze packet capture files to identify data records associated with anomalies and, in some embodiments, suggest causes and/or solutions to the anomalies. Generally, the instructions cause processor 200 to read each data record of a packet capture file and compare the data in the records to reference data, sometimes referred to herein as “anomaly definitions”, stored in memory 202 that indicates the presence of an anomaly. For example, memory 202 may be pre-loaded with a number of anomaly definitions that each define a particular type of anomaly, such as “failure to receive data”, “failure to transmit data”, “dropping offline”, “high power consumption”, “failure to decrypt received data packets”, “packet received late” (i.e., outside of allowable time window), “packets received out of order”, etc. Each anomaly may comprise one or more patterns of data records indicative of each anomaly type. For example, the “failure to receive data” anomaly may be defined as when a) a high CRC error rate occurs, as evidenced by a number of failed CRC check results exceeding a predetermined threshold or b) a high number of retransmissions occur by a device attempting to make contact with the electronic device under test. The data records in a packet capture file are automatically compared by processor 200 against the anomaly definitions stored in memory 202, either alone or in combination with each other, to identify data records that substantially match one or more anomaly definitions. When a match is found, processor 200 may generate a packet capture file to emphasize the data records that match an anomaly definition and return the packet analysis file to a user of computer 104 for further review.

In one embodiment, an anomaly definition may comprise one or more user categories associations that determines whether an anomaly definition should be analyzed for a particular anomaly. For example, if a user of system 100 identifies him/herself as a device installer, when processing packet capture files, anomalies that are not annotated as relevant to such an installer may not be compared to data records of a packet capture file, in order to minimize the processing needed to identify relevant data records to the installer.

The following table is a non-exhaustive list of potential anomalies and associated data record patterns indicative of each anomaly for a Zwave-based electronic device:

TABLE 1

| Anomaly | Pattern | Cause | Solution |
|---|---|---|---|
| Excess Buffering | Back-to-back Acknowledgements | Noise floor is too close to the listen | Verify listen before talk threshold is set and |
| | from a single device | before talk threshold causing | utilized correctly. Look for causes of noise |
| | | buffering of packets when they | either external or internal to the device such |
| | | would normally be sent right away. | as a voltage boosting circuit or high speed |
| | | | data bus lines on the circuit board |
| | | | connected to components like DRAM or |
| | | | ethernet. |
| Supervision status is incorrect. | Records indicate device offline | Incorrect protocol implementation. | Run certification test tool on the command |
| | | | class implementation to see where it fails |
| | | | and correct the errors. |
| Supervision status indicates | Records where supervision status | S2 Encryption timing issues. General | Check RF, and check for known issues with |
| that encapsulated command | indicates command not processed | RF problems. The device actually | the S2 implementation. |
| was not processed. | | can't process the command because | |
| | | of an uknown issue with the device's | |
| | | state. | |
| Included Node Information | Included Node Information | Hardware or software reset. | Check for power issues: if battery powered, |
| Frame appearing | Frame appearing unexpectedly. | | look at power supply to the transceiver to |
| unexpectedly. OR Some | OR Some other frame like a | | see if the voltage unexpectedly falls below |
| other frame like a Wake | Wake Up Notification that | | reset voltage specified in the datasheet |
| Up Notification that | happens on power-up keeps | | usually when battery impedence is high |
| happens on power-up keeps | being sent unexpectedly. | | from a low battery or cold battery. Look in |
| being sent unexpectedly. | | | the hardware errata and SDK release notes |
| | | | for internal DCDC regulator issues. |
| Failure to communicate | Multiple protool stack level retries. | Poor RF performance of either the | Check antenna of both devices, and check |
| | | DUT or the controller or other node | for interference. |
| | | in the mesh network if hopping. | |
| Missed messages on | No records indicating successful | Poor RF performance or there is an | Re-Add/include DUT. |
| inclusion. | inclusion | internal software timing issue | |
| | | interrupting the inclusion process. | |
| CRC Error | Records indicate CRC errors | Software issue in the application | Check software for all places where |
| | from a specific device. | may be preventing radio from | interrupts are being disabled. |
| | | working correctly at critical times by | |
| | | locking up the core preventing it | |
| | | from servicing radio interrupts. | |
| General S2 encryption | ACKs but DUT still is retrying and | Poor RF performance. S2 | Check RF, and check for known issues with |
| problems. | also occasionally appending SPAN | implementation issues with timing. | the S2 implementation. |
| | messages to frames and also | | |
| | sending nonce updates. | | |
| Controller not setting wake- | Missing or non-ACK'd Wake | Missing or non-ACK'd Wake Up CC | Check RF, and check for latency in the |
| up or association on | Up CC configuring master | configuring master node ID. Missing | controller software where Controller might |
| including/adding a DUT. | node ID. Missing or non-ACK'd | or non-ACK'd (Multichannel) | be getting busy not able to send |
| | (Multichannel) Association Set | Association Set for the Lifeline | configurations. |
| | for the Lifeline association group. | association group. | |
| DSK wrong | KEX Fail command. | S2 Bootstrap failure probably from | Check S2 DSK is correct, and verify desired |
| | | DSK being wrong. Or Poor RF. | S2 Authenticated or Access is desired. |
| Sequence number is not | Sequence number in previous | Issue with protocol implementation. | Check for resets and protocol |
| incremented correctly | frame is being reset back to 1 | Device could being reseting. | implementation. |
| | or otherwise not incrementing | | |
| | as expected. | | |
| ACK from device has | Node A message to node B with | ACKs being buffered from noise | Look at source code |
| sequence number that doesn't | Sequence number of 8. | issue. See back to back ACKs. Bad | |
| match the frame it appears to | Node B ACK to A with sequence | porotocol implementation. | |
| be ACKing. | number that is not 8. | | |
| General Z-Wave mesh routing | General Z-Wave mesh routing | Poor RF or software bugs in a | Check if there is a particular node that is |
| errors. | errors. | node in the mesh preventing a | giving routing errors more often than others. |
| | | stable network. | |
| A particular periodic | Packets received outside a time | Unknown but something to manually | Look at source code |
| command is happening | window | look into. | |
| outside the period | | | |
| unexpectedly. | | | |
| Network Rejoin | Rejoin frequently. | RF Issue or software isssue. | Check RF design/layout |
| Z-Wave commands which are | Z-Wave commands which are | RF Issue or inclusion problem where | Re-Include/Add. |
| being broadcast instead of | being broadcast instead of | association was not set up correctly. | |
| single or multicast. | single or multicast. | | |
| Frame Errors | Too many frames above | Usually the developer's test | Use RF sheilded boxes or split the number of |
| | recommended for a reliable | engineers testing too many devices | devices up into multiple locations below the |
| | network. | in the same location at the same | limit. |
| | | time. | |
| DUT occasionally | No ACKs some times. | Usually a software issue where | Enable serial debug out of the DUT to |
| unresponsive. | | device is busy or asleep when it | analyze software flow for issues of going to |
| | | should not be. | sleep too fast or resetting. |

In another embodiment, rather than a simple comparison to static, anomaly definitions, the computer-executable instructions may comprise a trained machine learning model, sometimes known as a neural network model. In one embodiment, the trained machine learning model comprises a convolutional neural network model specially configured to automatically analyze packet capture files to identify data records associated with anomalies and, in some embodiments, suggest a cause and a potential solution to each of the anomalies. Convolutional neural networks are well-known in the art. To obtain a trained machine learning model capable of automatically analyzing packet capture files, an untrained model is trained with training data, for example, data records from packet capture files containing one or both of expected data records (i.e., data records associated with normal operation of an electronic device) and suspect data records (i.e., data records associated with anomalies of an electronic device).

In one embodiment, a trained model may produce a probable cause of an anomaly and a “confidence value” indicating how confident the trained model believes that it has correctly identified an anomaly. For example, if a packet capture file is applied to the trained model, containing multiple, back-to-back retransmissions, the trained model may indicate that the anomaly is a multiple, back-to-back retransmissions problem, and that the cause of this anomaly is either a) transmission power of a source device is too low, b) a target device is too far away from the source device, or c) the target device is defective. The trained model could provide a confidence value to each cause, such as a value between 0 and 1. In this example, the confidence value of cause a) might be calculated as 0.4, cause b) calculated as 0.9 and cause c) calculated as 0.1. Confidence values may be initially assigned to each potential cause of each potential anomaly and, in one embodiment, modified over time by the trained model as it receives feedback from a user of computer 104 as each anomaly is identified and a cause of each anomaly is predicted by the trained model. Processor 200 may use confidence values to emphasize suspect data records differently than other suspect data records based on the confidence value of each anomaly found.

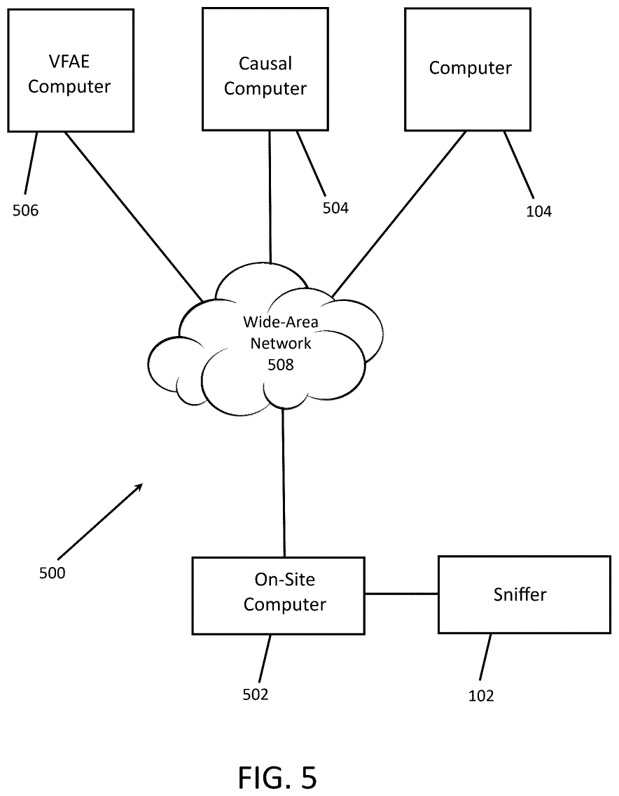

FIG. 5 is a functional block diagram of one embodiment of a system 500 for debugging electronic devices. Other embodiments may use fewer computers to perform the functionality described below, and in other combinations of on-site vs. cloud-based computers. System 500 comprises sniffer 102 coupled to on-site computer 502, which in turn is coupled to one or more of computers, in this environment, computer 104, causal computer 504 and virtual field application engineer computer 506 via wide-area network 508. Sniffer 102 monitors wireless RF transmissions between electronic devices, such as wireless sensors, smart control modules, smart thermostats, gateways or hubs, etc. in order to develop and/or troubleshoot one or more of the electronic devices. Sniffer 102 provides packet capture files to on-site computer 502 which is usually co-located with sniffer 102 and electronic devices under development and/or test. An engineer uses on-site computer 502 to capture packet capture files, each packet capture file comprising hundreds or even thousands of data records, each data record representative of a data packet transmitted by an electrical device and captured by sniffer 102. In order to aid the engineer to develop and/or troubleshoot one or more electronic devices, the engineer may provide one or more packet capture files to computer 104 via wide-area network 508, such as the Internet. It should be understood that while three separate computers are shown in FIG. 5 remote from on-site computer 502, the functionality provided by each of these computers may be combined and provided by a single computer, or two or more computers. It should be further understood that in other embodiments, the functionality of each of computers 104, 504 and/or 506 may be provided by on-site computer 502.

Each of the computers shown in FIG. 5 comprise well-known computer components, such as one or more processors, one or more memories, I/O, user interfaces, etc. Each of the computers executes processor-executable instructions that cause each computer to perform certain inventive and non-obvious processes. For example, one or more of the computers 104, 504 and 506 may be loaded each with a particular, trained machine learning model, each model trained specifically for a particular task. For example, computer 104 may be loaded with a first trained model designed to automatically analyze packet capture files and create packet analysis files having certain data records emphasized for inspection by a human or computer. Computer 504 may be loaded with a second learning model or other processor-executable instructions to receive packet analysis files and determine a cause of an anomalies associated with suspect data records in a packet capture file. Once a cause has been identified by computer 504, computer 504 may submit the cause and, in some embodiments, the packet analysis file, to computer 506, which may comprise third trained machine learning model, or other executable code, to determine potential solutions to anomalies and their causes provided by computer 504. For example, computer 506 may provide a suggestion to an operator of computer 502 to perform certain remedial actions, such as to modify a particular section of source code associated with an electronic device under test, or instructions for the operator to verify certain parameters associated with the electronic device under test, physical setup of various electronic devices in communication with other electronic devices, etc.

In one embodiment, computer 506 may determine that the cause of an anomaly as reported by computer 504 may not be correct. This may occur, for example, if 506 accesses source code of a device and determines that the reported cause could not be possible, or that it could be multi-faceted, based on the source code. In this case, computer 506 may collaborate with computer 504 to perform further analysis to correctly identify the cause of an anomaly. Also, in some embodiments, computer 504 may require information from computer 506 to correctly diagnose the cause of an anomaly.

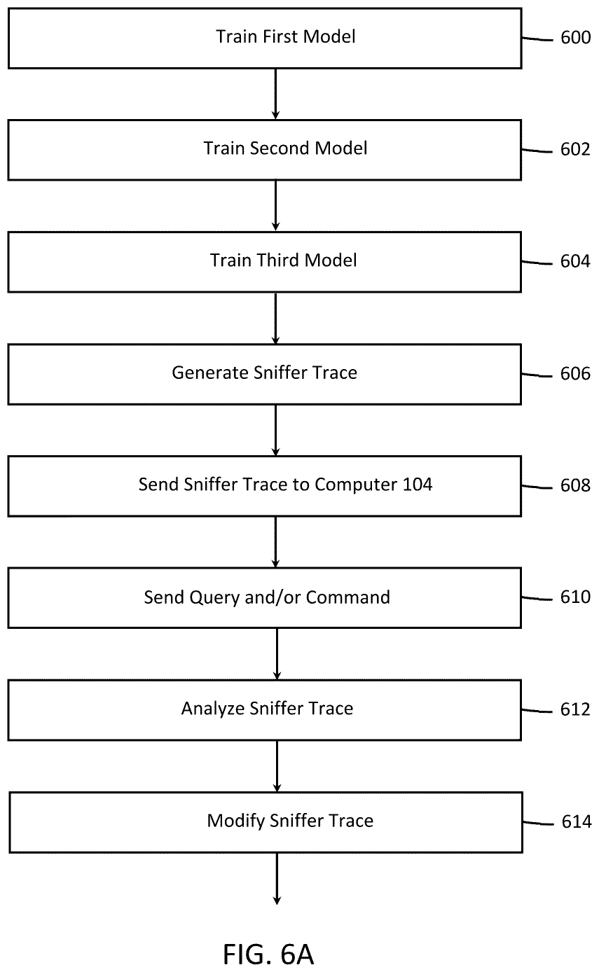

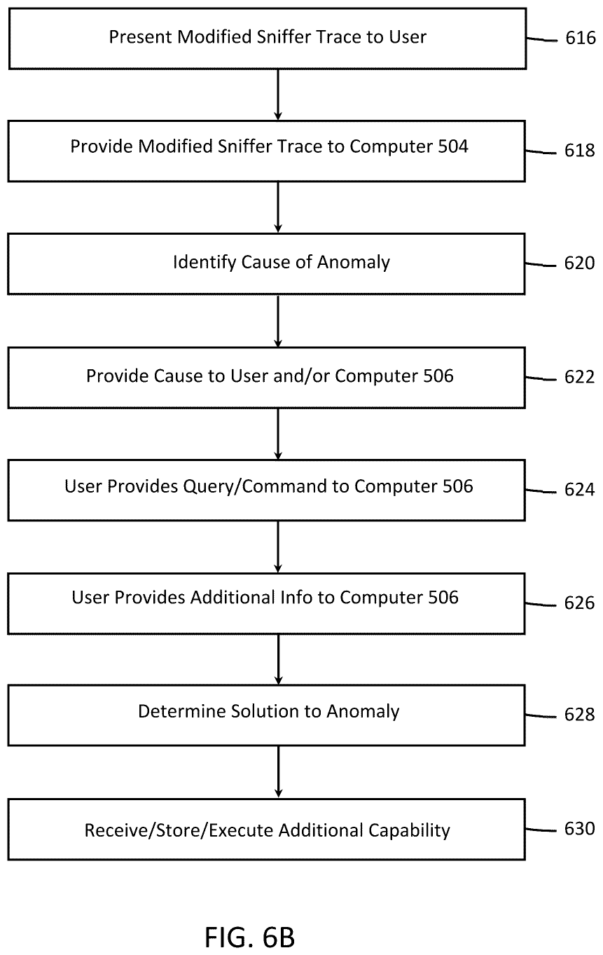

FIGS. 6A and 6B represent a flow diagram illustrating one embodiment of a method for debugging an electronic device using one or more trained machine learning models. In this embodiment, the method is used in connection with the elements shown in FIG. 5, where analysis of packet capture files is first performed by computer 104 executing a first trained machine learning model, computer 504 performing additional analysis using a second trained machine learning model, and computer 506 performing still additional analysis using third trained machine learning model. It should be understood, however, that the analysis described in the method of FIGS. 6A and 6B could alternatively be performed within a single computer or machine learning model, or a different number of computers than shown in FIG. 5. It should be understood that in some embodiments, not all of the method steps shown in FIGS. 6A and 6B are performed and that the order in which the steps are performed may be different in other embodiments.

It should also be understood that reference to internal components of computer 104, computer 504 and computer 506 may share the same reference numerals as the component shown in FIG. 2. For example, a processor within computer 104, computer 504 and computer 506 may each be referenced as processor 200.

At step 600, a first untrained machine learning model is trained to identify suspect data records in a packet capture file associated with an anomaly. For example, an untrained machine learning model comprising executable computer instructions representative of an untrained neural network model may be provided with thousands of data records from one or more packet capture files, with metadata indicating individual or multiple data records that indicate a properly-functioning electronic device and individual or multiple data records that indicate an anomaly. In the case of an anomaly, the training data (suspect data records of a packet capture file) may comprise an anomaly identification (ID) that identifies the kind of anomaly represented by the suspect data packets. For example, additional metadata may be provided in association with suspect data records indicating that the suspect data records are indicative of “not receiving data”, “dropping offline”, “no supervisor signal”, “not transmitting data”, etc. The metadata could also comprise information that ranks anomalies by severity, information that identifies possible solutions to each anomaly, source code of one or more electronic devices that could be associated with each anomaly, information that identifies potential causes of each anomaly, etc. After a predetermined number of data records and associated metadata is provided to the first untrained model, the first untrained model becomes a first trained model configured to at least detect suspect data records in packet capture files and to visually emphasize those data records. The first trained model may then be provided to computer 104.

In some embodiments, a packet capture file may be converted by processor 200 into a format readable by any of the trained models, for example, in the form of a textual format, such as the well-known JSON format. In a related embodiment, the formatted packet capture file may be processed by any of the trained models (or a public large-language model, such as ChapGPT) to convert the formatted packet capture file into readable paragraphs/bullet points, where this could be provided to any of the trained models.

In one embodiment, the data records and metadata used to train the model, above, may comprise data records associated with a single wireless protocol. In this case, the trained model may only be able to analyze packet capture files in accordance with the single wireless protocol. In another embodiment, an untrained model may be trained with data records in accordance with two or more wireless protocols. In this embodiment, once trained, the model may be able to analyze packet capture files associated with the two or more wireless protocols, detecting suspect packets differently from one protocol to another in accordance with each protocol's particular packet structure and/or operational flow. In a related embodiment, whether a model is trained with data records from one protocol or multiple protocols, a model may be trained to recognize suspect data packets of two or more wireless protocols in an “agnostic” fashion. For example, if a model has been trained with training data associated with a first wireless protocol, the model may be trained to recognize multiple, back-to-back retransmissions, as such an anomaly may be generally applicable to multiple wireless protocols. Similarly, if a model has been trained with training data associated with two or more wireless protocols, the trained model may be able to detect suspect data packets of a packet capture file associated with third wireless protocol.

In one embodiment, multiple models may be trained, each model trained in accordance with a particular wireless communication protocol. The trained models may all be loaded into computer 104 to analyze future packet capture files. In one embodiment, computer 104 is configured to receive and store multiple trained models, each associated with a particular wireless communication protocol. In one embodiment, computer 104 is configured to analyze packet capture files in accordance with one wireless communication protocol, and at some time later, configured to receive and store one or more trained models in memory 202, each trained to analyze packet capture files in accordance with one or more other wireless communication protocols, respectively. In some embodiments, a user may choose which of the trained models to analyze a particular packet capture file.

At step 602, a second untrained model may be trained to determine the cause of anomalies found by the first trained model described in step 600, above. In another embodiment, the first trained model is additionally trained to answer user queries and/or to provide information in response to user commands. Training this model may comprise providing packet analysis files to an untrained neural network model, each packet capture file comprising hundreds, thousands or even millions of data records, where at least some of the data records, or groupings thereof, comprise associated metadata, the metadata comprising indications of whether one or more data records are associated with an anomaly, an anomaly type or ID, an anomaly severity, likelihood of association with an anomaly, one or more causes of the anomaly and associated data records, likely queries or commands that could be issued by a user, etc. The second untrained model may be provided with many thousands of data records and associated metadata. After a predetermined number of data records and associated metadata is provided to the second untrained model, the second untrained model becomes a second trained model configured to at least provide one or more causes of detected anomalies identified by suspect data records. The trained model may then be provided to computer 504 or to computer 104.

At step 604, a third untrained machine learning model may be trained to use packet analysis files and the predicted causes of anomalies provided by the second model to determine solutions to anomalies. This model may be trained by providing hundreds, thousands or millions of packet analysis files or data records and metadata associated with particular data records, sets of data records, or entire packet capture files. The metadata may comprise one or more suspected causes of one or more anomalies and potential solutions to each anomaly. For example, the third untrained model of computer 506 may be provided with 100 packet analysis files from computer 104, each packet analysis file comprising 10,000 data records, some of which are emphasized as suspect data records associated with one or more anomalies. Metadata is also provided with the packet capture files to identify data records suspected of being associated with an anomaly, an identification of the anomaly, one or more suspected causes of the anomaly and one or more solutions. A “solution” may comprise a textual description of a technical solution to an anomaly, such as “Try moving the electronic device under test closer to the hub”, “Perform the following troubleshooting steps:”, “Unpair/re-learn device”, “Check source code”, “Reduce RF interference”, “Focus on incorrect message status”, etc. In one embodiment, a solution may comprise an identification of a portion of source code potentially associated with the anomaly and/or one or more suggested changes to the source code. After a predetermined number of data records and associated metadata is provided to the third untrained model, the third untrained model becomes a third trained model configured to at least provide one or more solutions to detect anomalies identified by suspect data records. The third trained model may then be provided to computer 506 or to computer 104.

At step 606, a user of on-site computer 502 may troubleshoot or develop an electronic device, such as electronic device 108, by capturing wireless network traffic using an RFPCT coupled to on-site computer 502. On-site computer 102 may execute a software application that generates a packet capture file, typically comprising hundreds or thousands of data records in accordance with a particular wireless communication protocol used by an electronic device under test, such as a Zwave wireless sensor in communication with a Zwave network hub. The packet capture file is generated by sniffer 102 and may then be presented to a user of on-site computer 502, typically an engineer or some other technical person. In one embodiment, the user may annotate the packet capture file by adding context to one or more data records, such as a notation that a problem started at a particular line or data record, or details of the conditions under which a packet capture file was captured, such as an identification of a version code of firmware in one or more devices in a network, the version of the stack used in the device under test, a version of an SDK used to generate the firmware in the device under test, an identification of a physical arrangement of the network devices, a date, time and name of an engineer capturing the packet capture file, where the testing was performed (i.e., in a home, hotel, test environment, etc.), a number and types of devices in the network, etc.

At step 608, the packet capture file is sent from on-site computer 502 to computer 104 via wide-area network 508. In addition to the packet capture file, a user may provide metadata such as the name of the electronic device under consideration, a model number of the device, a serial number of the device, a date and time that the packet capture file was recorded, a status of the user (i.e., developer, support tech, installer), etc.

At step 610, in one embodiment, a user of on-site computer 502 may additionally send a query or a command along with the packet capture file to computer 104. For example, the user may ask “What is wrong with the device under test?”, “Show me data records in the packet capture file associated with a particular event (such as the device dropping offline, the device transmitting back-to-back ACKs, encryption is out-of-sync) associated with the device under test, such as “Show me data records+/−10 records of when the device under test went offline”, “Show me all transmissions of device X”, “Show me all ACKs of device X”, “Show me data records matching pattern X” (where pattern X comprises a particular pattern of data records, such as receiving back-to-back retransmissions, transmitting back-to-back ACKs, receiving communications indicative of two devices re-synchronizing an encryption mechanism between them, a watchdog timer may have reset the device (look for packets that show wake-up, reset, or a presence of particular messages that should not be present, i.e., out of sequence, out of place messages, etc.), etc.

At step 612, the packet capture file, and any query or command, is received by computer 104 and automatically analyzed by processor 200 using the first, trained machine learning model stored in memory 202. Processor 200 analyzes the packet capture file and, in some embodiments, the metadata, query or command in accordance with the first, trained neural network model to identify suspect data records within the packet capture file that may be associated with an anomaly of the electronic device under test or relevant to the query or command.

At step 614, processor 200 generates a packet analysis file comprising, in one embodiment, a copy of the packet capture file with data records emphasized suspected of being associated with an anomaly and/or data records relevant to a query or a command, such as to highlight suspect data records in one or more colors, fonts, font size, etc. In some embodiments, colors can be used to indicate a likelihood, or confidence value, that the emphasized data records are, in fact, associated or causing an anomaly (with different emphasis placed on data records more likely to be associated or causing an anomaly), or relevant to a query or command, to indicate a severity of an anomaly associated with the emphasized data records (such as data records indicating very high-power consumption, data records indicating complete non-operation of an electronic device, etc.), and/or to differentiate one anomaly vs. another in the sniffer trice. Processor 200 may select particular ways to emphasis certain data records based on how the first model was trained.

In other embodiments, the packet analysis file may comprise other ways to bring attention to suspect data packets, such as simply identifying which data records are suspect, such as identifying line numbers in the packet capture file that are associated with suspect data records. In this case, the packet analysis file comprises a listing of such line numbers. In general, a packet analysis file comprises any information that identifies suspect data records, no matter what form it may take.

In one embodiment, generation of the packet analysis file may comprise generating a heat map, such as one or more of heat maps 302 and/or 304 discussed earlier herein.

In one embodiment, processor 200 may calculate a confidence value associated with an identification of an anomaly associated with suspect data records, indicating how confident the trained model of computer 104 believes that it has correctly identified an anomaly. For example, if a packet capture file is applied to the trained model, containing multiple, back-to-back retransmissions, the trained model may indicate that the anomaly is a multiple, back-to-back retransmissions problem, and that the cause of this anomaly is either a) transmission power of a source device is too low, b) a target device is too far away from the source device, or c) the target device is defective. The trained model could provide a confidence value to each cause, such as a value between 0 and 1. In this example, the confidence value of cause a) might be calculated as 0.4, cause b) calculated as 0.9 and cause c) calculated as 0.1. Processor 200 may use confidence values to emphasize suspect data records differently than other suspect data records based on the confidence value of each anomaly found.

In one embodiment, the packet analysis file, or a portion thereof (i.e., only suspect data records) may be provided as training data to the first trained model as an example of an anomaly and, in some embodiments, a confidence value in association with the predicted anomaly. In a related embodiment, only packet analysis files or suspect data records are provided to the first trained model when a confidence value is greater than a predetermined threshold, such as 80%.

At step 616, the packet analysis file is sent from computer 104 to either on-site computer 502, computer 504, or both, typically via wide-area network 508. In the case where the packet analysis file is sent to on-site computer 502, a user of on-site computer may view and manually analyze the packet analysis file and either a) continue manually analyzing the packet analysis file, b) send it to computer 504 for further analysis or c) send it to computer 504 with a query or a command, asking a question or issuing a command associated with the packet analysis file or a suspected anomaly. For example, the user may ask “What is wrong with the device X?”, “What is the cause of the retransmissions in lines X-Y of the packet debug file?”, “Why did device X drop offline?”, etc.

At step 618, the packet analysis file, and any query or command, is sent to computer 504.

At step 620, the packet analysis file, and any query or command, is received by computer 504, and analyzed by processor 200 using a second, trained machine learning model stored in memory 202 to identify a cause of one or more particular anomalies represented by the emphasized data records in the packet capture file and/or to answer the query or respond to the command. In one embodiment, in addition or alternatively to determining the cause, processor 200 may generate a textual summary of an entire packet capture file, in accordance with previous training. For example, after analyzing an entire packet capture file, the textual summary may indicate that technical problems are likely to exist with one or more identified electronic devices, that device X continuously exhibits problem Y, that device X intermittently exhibits problem Y, that a radio of a device is turning off too quickly resulting in always missing messages after a specific event, etc.

The second, trained machine learning model analyzes the packet analysis file, and any query or command in accordance with how it has been trained to recognize patterns in the packet capture files and, in some embodiments, in particular, those data records that have been emphasized by computer 104. As a result of this analysis, processor 200 may generate one or more potential causes of an anomaly, such as “Firmware Problem”, “Hardware problem”, “RF problem”, “Transmit problem”, “Receive problem”, or some other cause, such as those identified in Table 1 earlier herein.

In the case of a query or command, processor 200 analyzes such queries and commands using the second, trained machine learning model, in accordance with how the second, trained machine learning model was trained, and provides a response, based on how the second model was trained.

At step 622, computer 504 may send the packet analysis file, an identification of an anomaly, a suspected cause of the anomaly, and/or a response to a query or a response to a command to on-site computer 502, for manual review, and/or computer 506, for further analysis.

At step 624, on-site computer 502 receives the results from computer 504, and a user of on-site computer 502 may analyze the results manually. The user may then provide some or all of the results to computer 506 to determine potential solutions to the anomaly. In one embodiment, the user may provide a query or a command to computer 506, such as “Why did device drop packets?”, “How can I improve the RF performance of device X?”, “Provide me with a copy of the source code of device X”, “Identify source code applicable to the anomaly”, “Provide suggested source code modifications to fix the anomaly”, etc.

At step 626, on-site computer 502 may send the packet analysis file, an identify of the anomaly, and/or a cause of the anomaly, and a query or command, to computer 506. The user may send additional information as well, such as the make, model, serial number, firmware version, etc. to computer 506.

At step 628, computer 506 receives the packet analysis file, the identity of the anomaly, and/or the cause of the anomaly, the query or command, and/or the additional information, and processor 200 uses the third, trained machine learning model stored in memory 202 to determine a potential solution to answer the query and/or provide a solution to the anomaly. In one embodiment, computer 506 may have access to a library of documentation supporting a particular wireless communication protocol type used in the network under test, such as the entire Zwave specification, or portions thereof, which may be processed by the third, trained machine learning model to identify relevant sections of the documentation as a solution to an anomaly. In response, processor 200 may generate one or more of the following: a text-based response comprising a potential solution to the anomaly, a text-based response comprising a suggestion to check one or more operating characteristics of a device under test, a copy of source code associated with the electronic device under test, a suggestion to physically move the electronic device under test, a suggestion to check the battery voltage of the device under test, etc. In one embodiment, in addition or alternatively to determining one or more potential solutions to an anomaly, processor 200 may generate a textual summary of an entire packet capture file. For example, the textual summary may indicate that technical problems are likely to exist with one or more electronic devices, that device X continuously exhibits problem Y, that device X intermittently exhibits problem Y, that extra communications are occurring between devices X and Y to re-synchronize an encryption mechanism between the two devices (when an encryption mechanism between the two devices is preventing successful communications between the two).

In one embodiment, processor 200 may access source code of the device under test as stored in memory 202, or in some other memory or database, to identify sections of relevant source code associated with a particular anomaly or cause of the anomaly. In this embodiment, processor 200 may provide one or more sections of the source code relevant to the anomaly to the user via a wide-area network 508. In a related embodiment, identifications of known anomalies may be stored in memory 202, which may comprise a vector database, in association with relevant source code and suggested solutions to each anomaly, such as solutions to common coding errors depending on the anomaly. In one embodiment, processor 200 may suggest modifications to one or more sections of the source code associated with the device under test by identifying an anomaly in memory 202 and retrieving an associated solution. For example, processor 200 may identify an anomaly and retrieve a section of source code from memory 202 associated with the anomaly. Processor 200 may analyze the section of source code to determine a problem with the source code, such as identifying an error-reporting function in the source code that returns a value of either “OK” or “Bad”, where a suspect data record reporting an error comprises a status of “OK”. Processor 200, in response, may then generate source code that fixes, or attempts to fix the problem, and provides this source code to the user via wide-area network 508. The user, in response, may incorporate the change source code into the source code files associated with the device under test, compile the source code, flash the resulting executable code into the electronic device under test, and re-test the electronic device.

The third, trained machine learning model analyzes the packet analysis file and any associated queries or commands, additional data, etc. in accordance with how it has been trained to recognize patterns in the packet capture files and, in some embodiments, in particular, those data records that have been emphasized by computer 104.

In the case of a query or command, processor 200 analyzes such queries and commands using the third, trained machine learning model, in accordance with how the third, trained machine learning model was trained. For example, the third, trained machine learning model may have been trained to recognize particular suspect data records as being related to a certain anomaly and cause and, therefore, one or more solutions to the anomaly or cause may have been provided in the training data.

In one embodiment, the results from computer 506 may be tailored with respect to a user type. For example, if a user previously provided a user type to any one or more of computers 502, 104, 504 and/or 506 indicating that the user is a customer support person, the results from computer 506 may be tailored to patterns for anomalies a customer support person might see in the field. A device developer may receive all results from computer 506, or only suspect data records indicative of protocol conformance problems and/or hardware issues. An installer may be alerted only to suspect data records associated with RF communication patterns.

At step 630, processor 200 of computer 104 may receive additional processor-executable instructions associated with an additional capability of system 500, such as a capability of analyzing packet capture files associated with a new wireless communication protocol, a capability of analyzing packet capture files for new types of anomalies, etc. Processor 200 may identify the additional processor-executable instructions as an additional capability and store them in memory 202. In one embodiment, from then on, processor 200 may analyze packet capture files based on existing capabilities as well as any added capabilities. In one embodiment, a user may be presented with a listing of capabilities, such as a listing indicating the types of wireless communication protocols supported, a listing of anomaly types, etc. The user may select a particular wireless communication protocol and/or one or more anomaly types for analysis by computer 104 used to identify suspect data records in a packet capture file. This may reduce a volume of emphasized data records from computer 104, making it easier for the user to troubleshoot the electronic device under test.

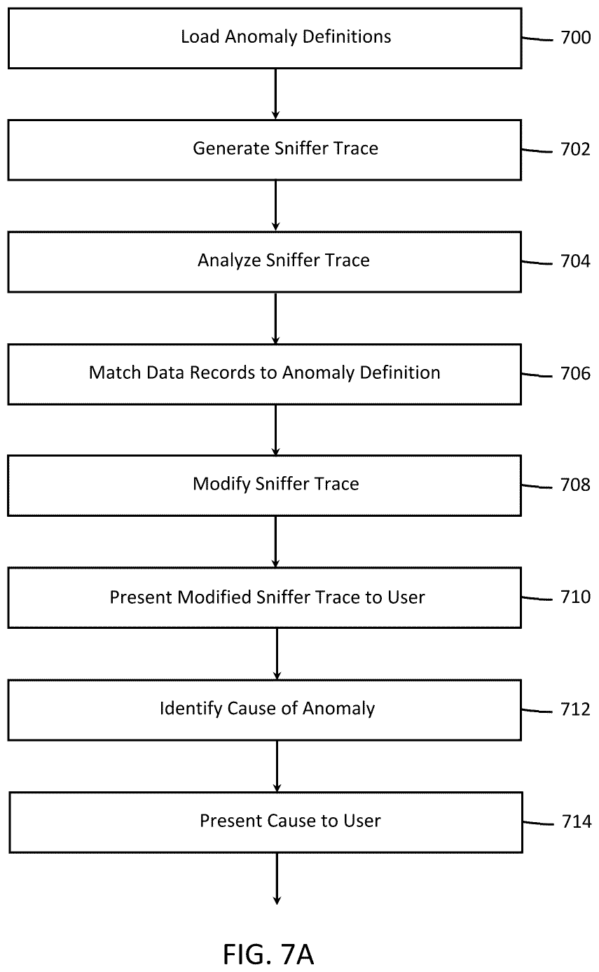

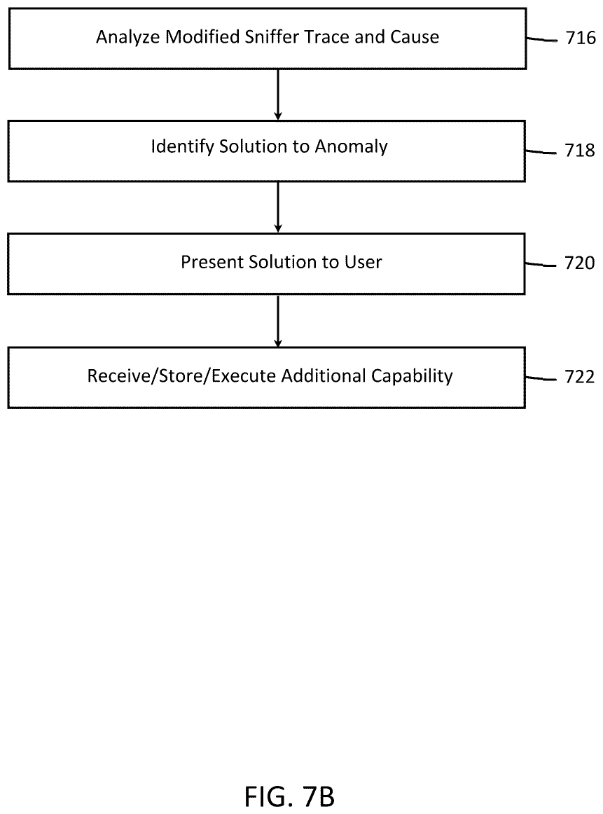

FIGS. 7A and 7B represent a flow diagram illustrating another embodiment of a method for debugging an electronic device using anomaly definitions by on-site computer 502. It should be understood that in some embodiments, not all of the method steps shown in FIGS. 7A and 7B are performed and that the order in which the steps are performed may be different in other embodiments.

At step 700, processor 200 of on-site computer 502 is loaded with a plurality of anomaly definitions, each definition identifying a possible, particular anomaly of an electronic device under test and representative data records from one or more packet capture files indicating the presence of each of the possible, particular anomalies. In some embodiments, additional data may be associated with each anomaly definition, such as information that ranks anomalies by severity, information that ranks anomalies by severity, information that identifies possible causes of each anomaly, information that identifies possible solutions to each anomaly, information that ranks a certainty of a cause or a solution, source code, or a reference address thereto, of one or more electronic devices that could be associated with each anomaly, etc. In any case, anomaly definitions are stored by processor 200 in memory 202.

In one embodiment, the data records of each anomaly definition may be associated with a single wireless protocol. In this case, on-site computer 502 may only be able to analyze packet capture files in accordance with the single wireless protocol. In another embodiment, anomaly definitions may be protocol-specific, and multiple protocols may be supported. For example, some anomaly definitions may be associated with the Zwave protocol while others may be associated with the Zigbee protocol. Each anomaly definition may comprise information that identifies the definitions as associated with a particular wireless communication protocol.

At step 702, a user of on-site computer 502 may troubleshoot or develop an electronic device, such as electronic device 108, by capturing a packet capture file of network traffic from sniffer 102. The packet capture file typically comprises hundreds or thousands of data records in accordance with a particular wireless communication protocol used by an electronic device under test, such as a Zwave wireless sensor in communication with a Zwave network hub. The packet capture file is generated by sniffer 102 and provided to on-site computer 502, which may then be presented to a user of on-site computer 502 via a display of on-site computer 502, typically an engineer or some other technical person.

At step 704, in one embodiment, the user of on-site computer 502 causes the packet capture file to be analyzed by processor 200. In one embodiment, the user may additionally submit a query or a command after initially viewing the packet capture file. For example, the user may ask “What is wrong with the device under test?”, “Show me data records in the packet capture file associated with a particular event (such as the device dropping offline, the device transmitting back-to-back ACKs, the device XXXXX?) associated with the device under test”, “Show me data records+/−10 records of when the device under test went offline”, “Show me all transmissions of device X”, “Show me all ACKs of device X”, etc.

The packet capture file is analyzed by processor 200 by comparing the data records in the packet capture file to the anomaly definitions stored in memory 202. In particular, processor 200 may evaluate the data records in the packet capture file in comparison to the data records contained in each anomaly definition to identify when a substantial match is found. If a query or command is also provided with the packet capture file, processor 200 evaluates the query or command to tailor the analysis to the query or command. For example, if a command to show data records plus and minus 10 records of when a device under test went off-line, processor 200 will analyze the packet capture file to identify any data records indicating that the electronic device went off-line.

At step 706, processor 200 may identify one or more anomaly definitions that comprise one or more patterns of data records that substantially match one or more patterns of data records in the packet capture file and/or data records that are relevant to a query or a command.

At step 708, processor 200 may generate a packet analysis, the packet analysis file emphasizing suspect data records, i.e., data records that substantially match data records of at least one anomaly definition, such as to highlight suspect data records in one or more colors, fonts, font size, etc. An identification of each suspected anomaly may also be provided (an “anomaly ID”). Data records relevant to a query or a command may also be emphasized. In some embodiments, processor may retrieve a “severity indicator” from an identified anomaly definition and generate the packet capture file in relation to the severity indicator. For example, for severe anomalies, related data records of the packet capture file may be colored in red, while for less-severe anomalies, related data records could be highlighted in yellow.

In one embodiment, as explained above, modification of a packet capture file may comprise generating a heat map, such as one or more of heat maps 302 and/or 304 discussed earlier herein. A heat map may be included with a packet analysis file, emphasizing suspect data records potentially associated with one or more anomalies.

At step 710, in one embodiment, the packet analysis file may be visually presented to the user of on-site computer 502. The user may manually analyze the packet analysis file and either a) continue manually analyzing the packet analysis file or b) continue to have the packet analysis file analyzed by on-site computer 502. In the case where the packet analysis file is further analyzed by on-site computer 502, the user may provide additional information as well, such as the make, model, serial number, firmware version, etc. of a device under test to un-site computer 502. The user may additionally enter a query or a command, asking a question or issuing a command associated with the packet analysis file or a suspected anomaly. For example, the user may ask “What is wrong with the device X?”, “What is the cause of the retransmissions in lines X-Y of the packet analysis file?”, “Why did device X drop offline?”, etc.

At step 712, in another embodiment, processor 200 of on-site computer 502 analyzes the packet analysis file without presenting the packet analysis file to the user. At this step, processor 200 analyzes the packet analysis file and, in some embodiments, one or more anomaly IDs, to identify one or more possible causes of the one or more anomalies emphasized in the packet analysis file and/or identified by the anomaly ID(s). In one embodiment, in addition or alternative to determining the causes, processor 200 may generate a textual summary of the packet analysis file. For example, the textual summary may indicate that a number of anomalies exist in association with the electronic device under test, or some other device, along with a listing of the anomalies and associated, potential causes.

In one embodiment, processor 200 analyzes the packet analysis file by comparing an identification of each emphasized data records, and in some embodiments, one or more anomaly IDs, with a plurality of anomaly causes that have been pre-stored in memory 202 in association with each potential anomaly. The potential causes may be stored in association with anomaly IDs. An exemplary list of such causes for different anomalies is shown in Table 1, presented earlier herein.

In one embodiment, at step 714, the suspected cause of each anomaly identified previously may be presented to the user of on-site computer 502. The user may a) manually analyze the packet analysis file and the suspected cause of each anomaly, or b) continue analyzing the packet analysis file, the anomaly IDs and the suspected causes of any anomalies using on-site computer 502. In the case that the user utilizes on-site computer 502, the user may send additional information as well, such as the make, model, serial number, firmware version, etc. to computer 506. The user may additionally enter a query or a command, asking a question or issuing a command, such as “What is the solution to the anomalies of electronic device X?”, “What is the solution to the retransmissions in lines X-Y of the packet analysis file?”, etc.

In another embodiment, at step 716, on-site computer 502 analyzes the packet analysis file, the identified anomalies, the suspected causes and/or any additional information automatically without presentation to the user. Processor 200 analyzes the packet analysis file, the identified anomalies, the suspected causes and/or any additional information provided by the user to determine one or more potential solutions for each anomaly. Processor 200 may identify one or more solutions of an anomaly by comparing the anomaly ID or the anomaly cause to a listing of possible solutions pre-stored in memory 202 in association with anomaly IDs and/or anomaly causes. This information may be contained within anomaly IDs.

In one embodiment, processor 200 may access source code stored in memory 202 associated with the device under test. Processor 200 may identify portions of the source code relevant to any identified anomalies and, in one embodiment, identify a modification to the relevant portions of the source code that may eliminate the anomaly. In this embodiment, memory 202 may be pre-stored with a plurality of examples of proper source code syntax for performing various operations, such as looping, function calls, up-to-date command class definitions, compare class is returning wrong result-use a copy of a different command class, either in code or in documentation; And processor 200 may analyze the source code to find instances of source code that are not written in proper syntax. Processor 200 may then look up the type of syntax error in memory 202 and retrieve modified source code that may alleviate the anomaly.

At step 718, processor 200 may generate one or more of the following in response to identifying a potential solution to an anomaly: a text-based response comprising the potential solution to the anomaly, a text-based response comprising a suggestion to check one or more operating characteristics of a device under test, provide a copy of at least a portion of source code associated with the device under test (source code of a variety of devices may be pre-stored in memory 202), the portion identified by processor 200 as being relevant to the anomaly or the cause of the anomaly, etc.

At step 720, the user of on-site computer 502 may visually review the potential solutions to the anomalies from un-site computer 502 and use the information to help troubleshoot the anomalies with the electronic device under test.

At step 722, processor 200 may receive additional processor-executable instructions associated with an additional capability of system 500, such as a capability of analyzing packet capture files associated with a new wireless communication protocol, a capability of analyzing packet capture files for new types of anomalies, new anomaly definitions, etc. Processor 200 may identify the additional processor-executable instructions as an additional capability and store them in memory 202. In one embodiment, from then on, processor 200 may analyze packet capture files based on existing capabilities as well as any added capabilities. In one embodiment, a user may be presented with a listing of capabilities, such as a listing indicating the types of wireless communication protocols supported, a listing of anomaly types, etc. A user may select a particular wireless communication protocol and/or one or more anomaly types for analysis of a packet capture file by processor 200. This may reduce a volume of emphasized data records from un-site computer 502, making it easier for the user to troubleshoot the electronic device under test.

Although specific advantages have been enumerated above, various embodiments may include some, none, or all of the enumerated advantages.

Other technical advantages may become readily apparent to one of ordinary skill in the art after review of the foregoing figures and description.

It should be understood at the outset that, although exemplary embodiments are illustrated in the figures and described above, the principles of the present disclosure may be implemented using any number of techniques, whether currently known or not. The present disclosure should in no way be limited to the exemplary implementations and techniques illustrated in the drawings and described above.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. The article “a” means “one or more”.

To aid the Patent Office and any readers of any patent issued on this application in interpreting the claims appended hereto, there is no intention that any of the appended claims or claim elements invoke 35 U.S.C. 112 (f) unless the words “means for” or “step for” are explicitly used in the particular claim.

What is claimed is:

1. A system for debugging an electronic device, comprising:
an RF packet capture tool for detecting RF data packets transmitted in a wireless network comprising the electronic device and for generating a packet capture file comprising a plurality of data records each associated with one of the RF data packets, respectively; and
a computer, comprising a memory for storing computer-executable instructions and a processor for executing the processor-executable instructions that causes the computer to:
identify data records of the packet capture file that indicate an anomaly associated with the electronic device;
generate a packet analysis file from the packet capture file comprising a copy of the data records and visually emphasizing data records in the packet analysis file that have been identified as causing the anomaly for ease of debugging the electronic device; and
provide the packet analysis file to a display for viewing by a user of the system.

2. The system of claim 1, wherein the computer-executable instructions comprise further instructions that causes the computer to:
identify a potential solution to the anomaly; and
present the potential solution to the user.

3. The system of claim 1, wherein the processor-executable instructions comprises a machine learning model trained to identify a potential cause of the anomaly based on the packet capture file.

4. The system of claim 1, wherein the memory is further configured to store a plurality of anomaly definitions, each one identifying a possible, particular anomaly with the electronic device and each one comprising data records representative of each of the possible, particular anomalies, respectively, wherein the computer-executable instructions comprise further instructions that causes the computer to further:
receive a first anomaly definition identifying a first potential anomaly with the electronic device and comprising data records representative of a presence of the first potential anomaly;
add the first anomaly definition to a plurality of other anomaly definitions to the memory; and
use the first anomaly definition to identify the first anomaly of the electronic device.

5. The system of claim 4, wherein the computer further comprises a user interface coupled to the processor, wherein the computer-executable instructions comprise further instructions that causes the computer to further:
receive an indication from the user via the user interface to activate the first anomaly definition; and
analyze the packet capture file in accordance with the first anomaly definition.

6. The system of claim 1, wherein the computer-executable instructions comprise further instructions that further causes the computer to:
generate a textual summary of the packet capture file, the textual summary comprising an indication of an overall performance of the electronic device based on the packet capture file.

7. The system of claim 1, wherein the computer-executable instructions that causes the computer to emphasize the data records that have been identified as indicating the anomaly comprises instructions that causes the computer to:
identify first data records having a first likelihood of being associated with the anomaly;
identify second data records having a second likelihood of being associated with the anomaly;
emphasize the first data records in a first manner to indicate a higher likelihood of causing the anomaly than the second records; and
emphasize the second records in a second manner to indicate a lower likelihood of causing the anomaly than the first records.

8. The system of claim 1, wherein the computer further comprises a user interface coupled to the processor, wherein the computer-executable instructions comprise further instructions that further causes the computer to:
receive an indication via the user interface of a user type of the user; and
modify the packet analysis file to produce a modified packet analysis file in accordance with the user category.

9. The system of claim 1, wherein the computer further comprises a user interface coupled to the processor, wherein the computer-executable instructions comprise further instructions that further causes the computer to:
receive a query from the user via the user interface asking the computer to identify data records in the packet capture file associated with a second anomaly associated with a second electronic device particular anomaly of the electronic device;
in response to receiving the query, identify second suspect data records that indicate the second anomaly associated with the second electronic device;
modify the packet capture file to produce a modified packet analysis file, wherein modifying the second packet capture file comprises visually emphasizing at least the second suspect data records for ease of debugging the electronic device; and
display the modified packet analysis file to a user.

10. The system of claim 1, wherein the processor-executable instructions that cause the computer to identify the data records of the packet capture file that indicate the anomaly comprises instructions that causes the computer to identify the data records in accordance with a first wireless communication protocol, and wherein the processor-executable instructions comprise further instructions that causes the computer to further:
receive further processor-executable instructions for identifying the data records that indicate the anomaly in accordance with a second wireless communication protocol; and
identify the data records in the packet capture file that indicate the anomaly in accordance with the second wireless communication protocol.

11. The system of claim 1, wherein the computer further comprises a user interface coupled to the processor, wherein the computer-executable instructions comprise further instructions that further causes the computer to:
receive a query from the user via the user interface asking the computer to identify a particular pattern of data records in the packet capture file indicative of the anomaly.

12. The system of claim 2, wherein the memory further stores source code of the electronic device, and wherein the computer-executable instructions that causes the computer to identify a solution to the anomaly comprises instructions that causes the computer to:
identify a portion of the source code potentially associated with the anomaly based on the data records identified by the computer associated with the anomaly.

13. The system of claim 12, wherein the computer-executable instructions comprise further instructions that further causes the computer to:
analyze the identified source code portion for errors;
modify the source code to potentially resolve the anomaly; and
provide the modified portion of the source code to the user for evaluation.

14. A method for debugging an electronic device, comprising:
generating a packet capture file from RF data packets received by an RF packet capture tool located in a wireless network, the packet capture file comprising a plurality of data records each associated with one of the RF data packets, respectively;
identifying suspect data records that indicate an anomaly associated with the electronic device;
generating a packet analysis file from the packet capture file, wherein generating the packet capture file comprises copying the data records of the packet capture file into the packet analysis file and visually emphasizing at least the suspect data records for ease of debugging the electronic device; and
displaying the packet analysis file to a user.

15. The method of claim 14, further comprising:
identifying a potential solution to the anomaly; and
presenting the potential solution to the user.

16. The method of claim 14, wherein identifying the suspect data packets comprises:
training a machine learning model to generate a trained machine learning model; and
analyzing the packet capture file by the trained machine learning model.

17. The method of claim 14, further comprising:
storing a plurality of anomaly definitions, each one identifying a possible, particular anomaly with the electronic device and each one comprising data records representative of each of the possible, particular anomalies, respectively;
receiving a first anomaly definition identifying a first potential anomaly with the electronic device and comprising data records representative of a presence of the first potential anomaly; and
adding the first anomaly definition to a plurality of other anomaly definitions.

18. The method of claim 17, comprising:
receiving an indication from the user via a user interface to activate the first anomaly definition; and
analyze the packet capture file in accordance with the first anomaly definition.

19. The method of claim 14, further comprising:
generating a textual summary of the packet capture file, the textual summary comprising an indication of an overall performance of the electronic device based on the packet capture file.

20. The method of claim 14, wherein emphasizing the data records that have been identified as indicating the anomaly comprises:
identifying first data records having a first likelihood of being associated with the anomaly;
identifying second data records having a second likelihood of being associated with the anomaly;
emphasizing the first data records in a first manner to indicate a higher likelihood of causing the anomaly than the second records; and
emphasizing the second records in a second manner to indicate a lower likelihood of causing the anomaly than the first records.

21. The method of claim 14, further comprising:
receiving an indication of a user type of the user; and
modifying the packet analysis file to produce a modified packet analysis file in accordance with the user category.

22. The method of claim 14, further comprising:
receiving a query from the user asking to identify data records in the packet capture file associated with a second anomaly associated with a second electronic device;
in response to receiving the query, identifying second suspect data records that indicate the second anomaly associated with the second electronic device;
modifying the packet capture file to produce a modified packet analysis file, wherein modifying the packet capture file comprises visually emphasizing at least the second suspect data records for ease of debugging the electronic device; and
displaying the modified packet analysis file to a user.

23. The method of claim 14, wherein identifying the data records of the packet capture file that indicate the anomaly comprises identifying the data records in accordance with a first wireless communication protocol, wherein the method further comprises:
receiving further processor-executable instructions for identifying the data records that indicate the anomaly in accordance with a second wireless communication protocol; and
identifying the data records in the packet capture file that indicate the anomaly in accordance with the second wireless communication protocol.

24. The method of claim 14, further comprising:
receiving a query from the user asking to identify a particular pattern of data records in the packet capture file indicative of the anomaly.

25. The method of claim 15, wherein the memory further stores source code of the electronic device, and wherein the computer-executable instructions that causes the computer to identify a solution to the anomaly comprises instructions that causes the computer to:
identify a portion of the source code potentially associated with the anomaly based on the data records identified by the computer associated with the anomaly.

26. The method of claim 25, wherein the computer-executable instructions comprise further instructions that further causes the computer to:
analyze the identified source code portion for errors;
modify the source code to potentially resolve the anomaly; and
provide the modified portion of the source code to the user for evaluation.
